(19) United States
(12) Patent Application Publication
(10) Pub. No.: US 2019/0058682 A1
(43) Pub. Date: Feb. 21, 2019

(54) Panel discussions in a social media platform

(71) Applicant: Cakes Inc., Mountain View, CA (US)

(72) Inventors: Christopher Rose MacAskill, Mountain View, CA (US); Brian Martin Strong, San Jose, CA (US)

(21) Appl. No.: 15/999,211

(22) Filed: Aug. 17, 2018

Related U.S. Application Data
(60) Provisional application No. 62/546,912, filed on Aug. 17, 2017.

(51) Int. Cl. H04L 12/58; H04L 12/18; H04L 29/06; G06F 17/30

(52) U.S. Cl. CPC H04L 51/32; H04L 12/1822; G06F 17/30994; G06F 17/30864; H04L 63/104

(57) ABSTRACT

System and methods for facilitating interactive panel discussions online are described. In an embodiment, a networked computing platform allows users to set up interactive communications sessions as public, private, or panel discussions. In an interactive panel discussion, invited participants are able to post information such as messages, images, video, etc. Users that are not invited participants in the panel discussion can view the panel discussion and, in some situations, may be provided mechanisms for limited interaction, for example through limited reactions to panel conversation posts.

### CROSS-REFERENCE TO RELATED APPLICATION(S)

This application claims the benefit of U.S. Provisional Patent Application Ser. No. 62/546,912 filed on Aug. 17, 2017, and titled “PANEL DISCUSSIONS IN A SOCIAL MEDIA PLATFORM,” which is incorporated by reference herein in its entirety.

### BACKGROUND

Several network-based tools are available to facilitate synchronous and asynchronous communications among multiple users. Examples include chat applications, instant message applications, social media platforms, web forums, etc. In any of these current systems the facilitated discussions can be set for private communications (i.e., only certain users are allowed to participate) or public communications (i.e., any user is allowed to participate).

### BRIEF DESCRIPTION OF THE DRAWINGS

One or more embodiments of the present disclosure are illustrated by way of example and not limitation in the figures of the accompanying drawings, in which like references indicate similar elements.

FIG. 1A is a diagram of an example operating environment for providing interactive panel discussion sessions;

FIG. 1B is a diagram of an example interactive discussion platform that may be implemented as part of the environment depicted in FIG. 1B;

FIG. 2 is a diagram that illustrates the roles of various user types during a panel discussion;

FIG. 3A shows a flow chart of an example process for providing an interactive panel discussion;

FIG. 3B shows a flow chart of another example process for providing an interactive panel discussion;

FIG. 3C shows a flow chart of yet another example process for providing an interactive panel discussion;

FIG. 4 shows a diagram illustrating how interactive panel discussion sessions may be linked

FIG. 5 shows a screen shot of an example graphical user interface element through which a host user can set up an interactive discussion session;

FIG. 6 shows a screen shot of an example graphical user interface displayed to user during an interactive discussion session;

FIGS. 7A-7B show a series of screenshots of an example graphical user interface through which a user can select and view interactive discussion sessions;

FIGS. 8A-8C show a series of screenshots of an example graphical user interface that illustrates an example interaction flow by a host user setting up a panel discussion;

FIGS. 9A-9B show a series of screenshots of an example graphical user interface that illustrates an example interaction flow by a user invited to participate in a panel discussion;

FIGS. 10A-10B show a series of screenshots of an example graphical user interface that illustrates an example interaction flow by a non-invited user viewing a panel discussion; and

FIG. 11 is a block diagram of a computer system as may be used to implement certain features of some of the embodiments.

### DETAILED DESCRIPTION

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section

### Overview

Existing tools for facilitating interactive discussions over a network can be configured for public communications and/or private communications. Public communications may encourage an open exchange of ideas free of restrictions, but can lead to inappropriate, undesirable, or otherwise unwanted content and interactions. Configuring interactive discussions to be private may prevent some unwanted content, but may also stifle open interaction. Introduced herein is a technique for providing interactive panel discussions that addresses the problems with existing communications technologies.

An interactive panel discussion may represent a middle ground between a private interactive discussion session and a public interactive discussion session. In an example, embodiment, a panel discussion is viewable to all registered users of, however only specifically invited (e.g., by a host) users can actively participate in the panel discussion by posting content. Non-invited users may, in some embodiments, be permitted limited interaction, for example, though submitting reactions (e.g., emoji) to content posted by invited panelists in the panel discussion. These limited interactions afforded to non-invited users can be controlled and curated while still providing the non-invited users a sense of participation and interaction. Accordingly, a panel discussion may achieve the openness that characterizes public discussions while avoiding the pitfalls of public discussions such as high volumes of unwanted content (e.g., inappropriate content, offensive content, irrelevant content, low-quality content, advertisements, etc.).

### Example Operating Environment

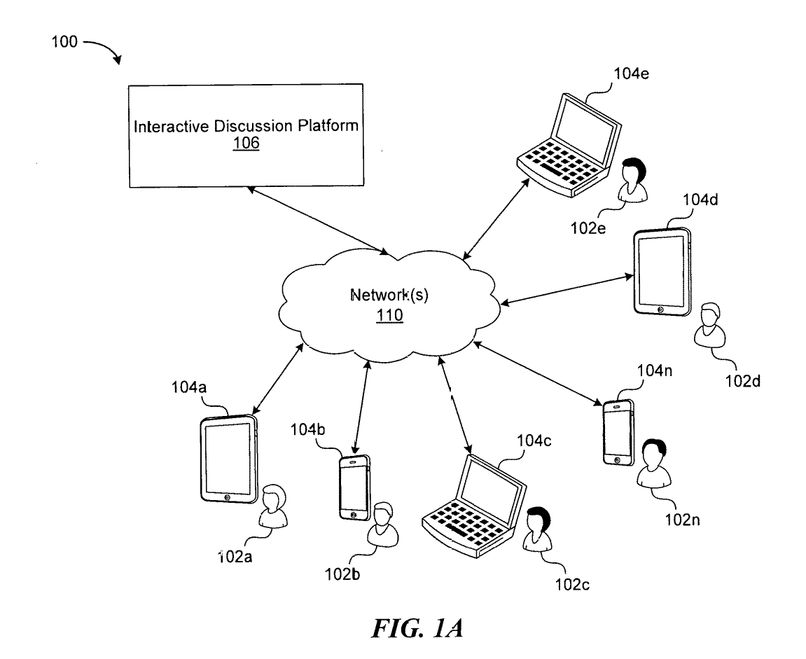

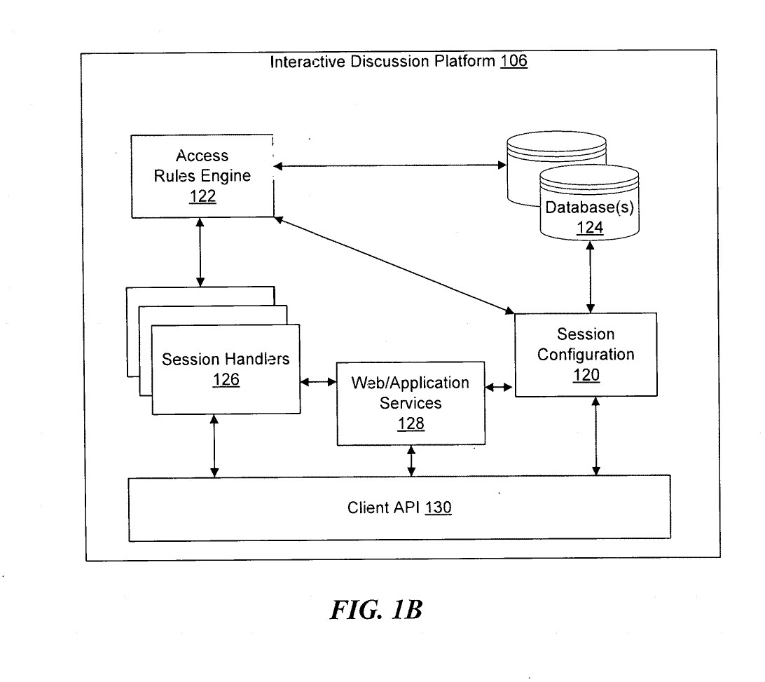

FIG. 1A is a diagram of an example operating environment in the form of a networked computer system 100 for enabling the functionalities described herein for interactive panel discussion sessions. As shown in FIG. 1A, the example networked computer system 100 may include multiple users 102a-102n using devices 104a-104n connected to a panel discussion platform (“Platform”) via one or more network(s) 110. As will be described, users 102a-102n may be classified into various role groups such as registered users, non-registered users, panel hosts, panel participants, etc.

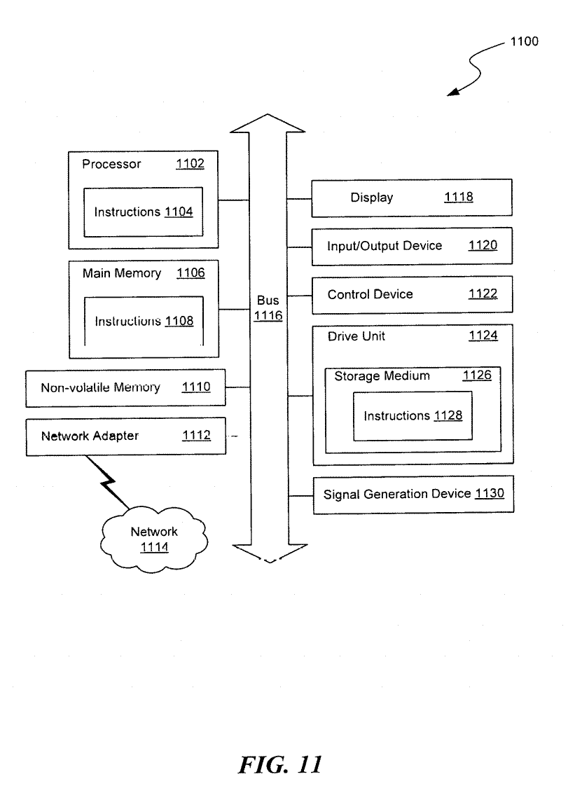

Devices 104a-104n may include any type of computing devices capable of transmitting and receiving data over a network 110. Examples of devices 104a-104n include smart phone devices (e.g., iPhone™, Android™ smart phones, etc.), tablet devices (e.g., iPad™, Android™ tablets, etc.), personal computers (including desktop, laptop and netbook computers), wearable devices (e.g., Apple Watch™, etc.), augmented reality and or virtual reality devices (e.g., Google Glass™, Microsoft Hololens™, Occulus Rift™, etc.) or any other devices capable of network communications. Additional details regarding internal computing components of the example devices 104a-104n, are described herein with respect to the example computer processing system 1100 shown in FIG. 11. According to some embodiments, devices 104a-104n may include client software (e.g., an application) configured to provide users 102a-102n access to functionalities provided by the Platform 106. According to some embodiments, users 102a-102n may access Platform 106 without specific client software, for example via a web interface.

As mentioned, system 100 may include a Platform 106 for hosting interactive discussion session among users 102a-n, including interactive panel discussions. Platform 106 may be implemented using one or more servers connected to one or more networks 110. In some embodiments, the Platform 106 may access services from other providers (not shown) (e.g., third-party social media providers, third-party content distribution providers, etc.) to provide the functionalities related to interactive panel discussion to users 102a-n as described herein. As with the devices 104a-n, computing devices associated with the Platform 106 and/or any other third-party services may include computing components as described with respect to example computer processing system 1100 shown in FIG. 11.

All the aforementioned devices, including devices 104a-104n and any other computing devices associated with Platform 106 and other third-party services, may be connected to each other through one or more wired and/or wireless networks, for example network 110. In general, network 110 broadly describes any combination of one or more local area networks (LAN), wide area networks (WAN), cellular networks (e.g., LTE), telephonic networks (e.g., PSTN), open public networks (e.g., the Internet), private networks (e.g., an intranet and/or the extranet), etc. Network 110 may be any collection of distinct networks operating wholly or partially in conjunction to provide connectivity to the devices 104a-104n, devices associated with Platform 106, and devices associated with any other third-party services and may appear as one or more networks to the serviced systems and devices.

FIG. 1B shows a block diagram showing components of the example Platform 106 shown in FIG. 1A. As shown in FIG. 1B, Platform 106 may include a session configuration module 120, an access rules engine 122, one or more databases 124, one or more session handlers 126, one or more web/application services 128, and a client application program interface (API) 130 through which to communicate with user devices 104a-n.

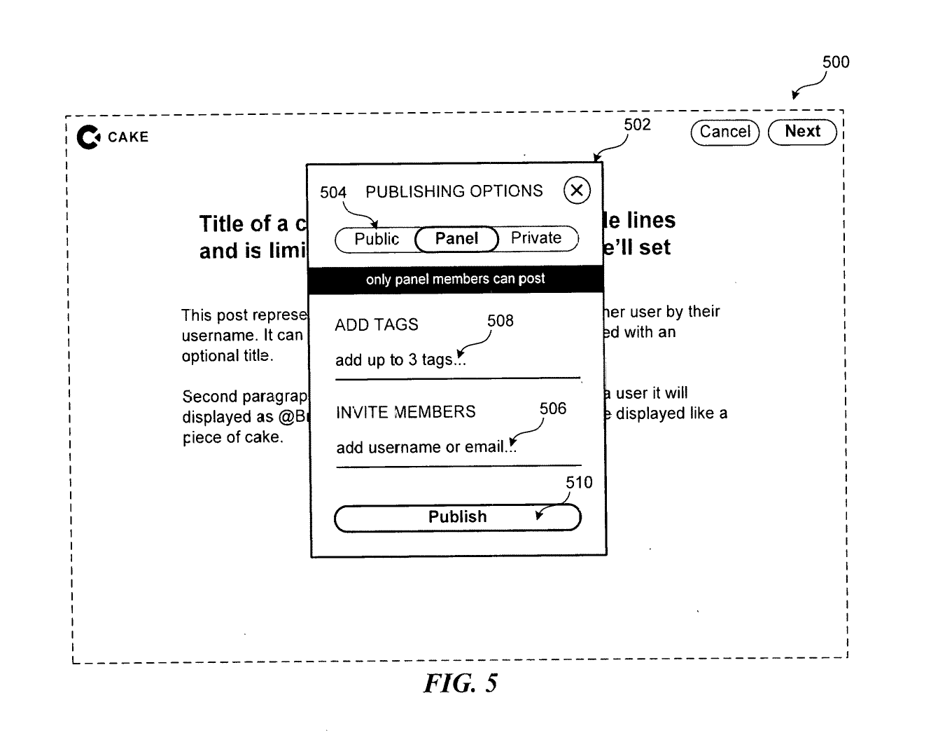

The session configuration module 120 may receive inputs from users 102a-n to configure new interactive discussion sessions to be hosted by Platform 106. As will be described in more detail, host users may provide input, for example, using their respective user devices to set up new interactive discussions sessions, for example, by specifying privacy settings, inviting participants, designating topic tags, etc. In some embodiments, the session configuration module, in conjunction with one or more web/application services, and the client API 130, may cause a graphical user interface (GUI) to be displayed at a user device through which a host user can set up an interactive discussion session. An example GUI for setting up an interactive discussion session is shown at FIG. 5.

The access rules engine 122 may be configured to generate access rules for interactive discussion sessions initiated by host users based on the inputs provided by the host users to the session configuration module 120. Access rules generated by the access rules engine 122 may govern how users are able to access and interact with each other in the interactive discussion sessions hosted by the Platform 106. Since each interactive discussion session may be associated with different privacy settings and in some cases different sets of invited users, each interactive discussion session may be associated with a corresponding access rule. As will be described, in some embodiments, interactive discussion sessions may be linked together based on inputs from host users. Accordingly, the access rules engine 122 may be configured to generate links between certain access rules or generate new access rules based on such links. As will be described in more detail, certain types of interactive discussions sessions, namely panel discussion, may involve multiple tiers of access for user based on their roles relative to the interactive discussions sessions. Accordingly, the access rules engine 122 may be configured to generate such multi-tiered access rules where appropriate.

The one or more databases 124 may be configured to store information used by the Platform 106 to provide various services to users. For example, the one or more databases 124 may store a listing of all the registered users of the Platform 106 (i.e., users having an account with a provider of Platform 106). As another example, the one or more databases may be configured to store a listing of all the currently active interactive discussion sessions hosted by the Platform 106. In some embodiments, each listing for an interactive discussion session may include or be associated with information pertaining to that interactive discussion session such as an access rule specific to the interactive discussion session, a listing of invited users to the interactive discussion session, a set of topic tags, etc.

The one or more session handlers 126 may maintain state and provide access for users to the one or more interactive discussion session, for example, based on the access rules generated by the access rules engine 122. Maintaining state may include receiving content submitted by users to an interactive discussion state, determining if submitted content complies with access rules, organizing submitted content into a discussion format, prioritizing submitted content, aggregating submitted reactions, etc. Providing access in this context may include generating or causing other processes to generate outputs (e.g., graphical, audio, etc.) based on the current state of an interactive discussion session to users seeking to access the interactive discussion. This may include determining if user request comply with access rules. In some embodiments, the one or more session handlers 126 store information associated with an interactive discussion session, for example, as metadata regarding session state and content in the one or more databases 124. In some embodiments, certain content submitted by users to interactive discussion sessions (e.g., images, audio, video, etc.) may be stored in databases 124 or other data storage facilities.

In some embodiments, client devices 104a-n access service provided by Platform 106 via a client API 130. For example, user devices 104a-n may execute applications locally with are configured to implement the client API 130). The client API 130 may monitor user interactions with the application to control access to interactive discussions sessions (e.g., output of content such as video, audio, photos, text, and/or other data included in a discussion). For example, the client API 130 may process inputs received at a user interface presented on the display of the user devices 104a-n.

In some embodiments, logic in an application executing on each user device 104a-n may control user authentication. For example, the application may be synced with one or more third-party social media accounts (e.g., Facebook®, Twitter®, Snapchat®) of the user corresponding to the user device. Control information and/or other user information can then be provided to a web/application service 128, which generally represents a collection of protocols or services that are used to exchange data between an application at a user device and information at the Platform 106, for example, stored in the one or more databases 124.

### Interactive Discussion Sessions

Platform 106 can be implemented to provide users access to interactive discussion sessions over the network 110. As used herein, the term “interactive discussion sessions” is broadly understood to include any type of online communication between users 102a-n using network connected devices 104a-n. For example, interactive discussion sessions may include text-based communications, posted images and/or video, streamed video, streamed audio, etc. Communications may be synchronous (e.g., real time chat) or asynchronous (e.g., a comment board). Interactive discussion sessions may include time limits with discernable beginning and end times (e.g., a live-streamed interactive video session) or may persist after initiation (e.g., a comment board). Interactive discussion sessions may be topic dependent (e.g., a session focused on motorcycles) or may be open ended.

### Privacy Settings

Interactive discussion sessions may include privacy settings that define access to various types of users with different user roles. For example, an interactive session may be set (e.g., by a host user) as public, private, or panel discussion.

A private interactive discussion session may be open only to other users invited by a host user that initiated the session. In such a private session, invited users may post content and view postings by other invited users. In contrast, registered and non-registered users that have not been invited to the private session are not allowed to view postings by the invited users, post their own content, or in any other way interact with private session.

In contrast to a private session, a public interactive session may be open to all users. For example, in an embodiment, all registered users are allowed to post content to a public interactive session and view content posted by other users. Further, in some cases, non-registered users may be allowed to view the postings by registered users during the interactive discussion session even if they are not allowed to post content.

A panel discussion session differs from both a private interactive session and a public interactive session. In an example, embodiment, a panel discussion session is viewable to all registered users of Platform 106, however only allows invited registered users to post content. The concept of a panel discussion is described in more detail below.

### User Roles

Users 102a-102n of Platform 106 may be classified into various groups such as registered users, non-registered users, panel hosts, panel participants, etc. Each of these groups may be associated with differing user roles related to an interactive session.

A registered user may include any users of Platform 106 that have a registered account with Platform 106. For example, a non-registered user may enter an identifier such as a user name or email address to become a registered user. Depending on the implementation, Platform 106 may require payment or a subscription to become a registered user. Conversely, non-registered users include any other users that do not have a registered account with the Platform 106.

A host user is a registered user that initiates an interactive discussion session. In other words, status as a host user may be specific to a given interactive discussion session. The host user may select a privacy setting for the interactive discussion session when initiating the interactive discussion session. For example, as previously mentioned, the interactive session may be set to public, private, or panel discussion. In the case of a private or panel discussion, the host user may additionally select one or more other users (likely other registered users) to participate in the interactive discussion session. In some cases, a registered user may require special credentials (e.g., an upgraded account) to become a host user and initiate a session. Alternatively, the ability to initiate a session may be granted to all registered users of the Platform 106.

An invited user (or invitee) is a registered user that has been invited by a host user to participate in one or more hosted interactive discussion sessions. In some embodiments, invited users are granted access rights to post content (e.g., in the form of text, video, images, etc.) in the interactive discussion session while other non-invited users (registered or not) are not granted such access.

A non-invited user is a user (registered or not) that has not been invited by a host user to participate in an interactive discussion session. Depending on the privacy setting for a given interactive discussion session, non-invited users may be allowed limited access and interaction with the discussion session short of posting content like an invited user. For example, in a panel discussion, non-invited registered users may be granted rights to post reactions (e.g., in the form of emoji) to content posted by invited users.

Users of the platform 106 may take on roles other than those mentioned above during some interactive discussion sessions. For example, an interactive discussion session may include a moderator user tasked with guiding the discussion amongst users, reviewing and possibly editing content posted by users, etc. In some situations, a host user may act as a moderator user. Alternatively, the moderator user may be another user (e.g., designated by the host user).

As another example, invited users to a private or panel discussion may take on different roles during the interactive session. For example, an invited user in a panel discussion may ‘hold the floor’ for a particular portion of the panel discussion. To guide the discussion, a moderator user may grant temporary floor status to one of a plurality of invited users to a panel discussion. An invited user granted floor status may have priority over other participating users to post content. For example, a posting by a user granted floor status may rise to the top of other previously submitted postings. In the context of a live video conference, other invited users may be muted in favor of the audio channel from an invited user granted floor status. Floor status may persist until a moderator user grants another user floor status, until a predetermined time has run out, or the invited user yields their floor status. In some embodiments, floor status may automatically cycle among multiple invited users participating in a panel discussion.

As another example, registered users may be identified as either regular registered users or registered “super” users or “celebrity” users (collectively referred to as super users). Status as a super user may be based, for example, on the number of followers the user has within the Platform 106 and/or through other social media platforms (e.g., Twitter™, Facebook™, Instagram™, etc.). Super users may be granted additional access rights and/or posting capabilities. For example, in a panel discussion, posts by an invited super user (e.g., a celebrity) may be prioritized in some manner over posts by regular invited users.

### Panel Discussions

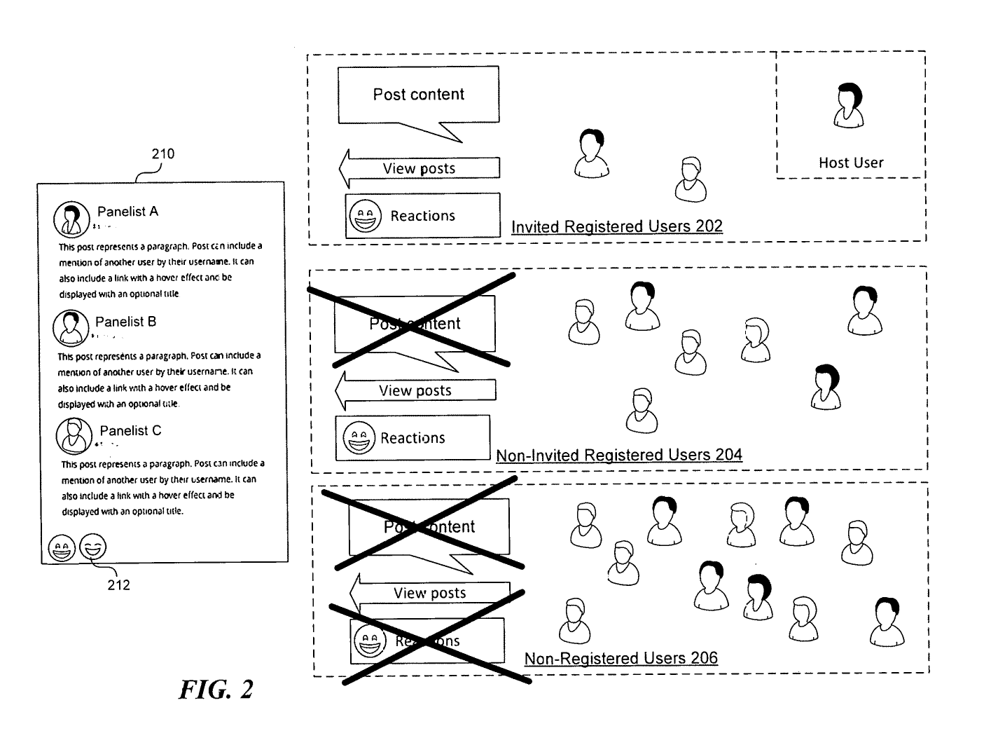

As previously discussed, an interactive discussion session can be set up as a panel discussion. FIG. 2 is a diagram that illustrates the roles of various user types during a panel discussion, according to some embodiments. As shown in FIG. 2, a host user may invite one or more other registered users to participate in a panel discussion. The host user along with the other invited users are collectively referred to as “invited registered users” 202. As shown in FIG. 2, in an embodiment, invited users are allowed by Platform 106 to post content into the interactive discussion session, view posts by other invited users 202, and in some cases, submit reactions (e.g., emojis) to the panel discussion.

In some embodiments, a panel discussion may be set up by a host user without inviting other users to participate. In other words, the invited registered users 202 may include only the host user that set up the panel discussion. In such an embodiment, the panel discussion including only the host user may accept posted content by the host user but will restrict posting of content by any other users. In some cases, non-invited users (registered and un-registered) may be able to view the content posted by the host user. Further, in some embodiments, non-invited users that are registered (e.g., as described in the following paragraph may be allowed limited interaction, for example, by submitting reactions (e.g., emoji).

Other registered users that have not been invited to participate in the panel discussion (collectively referred to as “non-invited registered users” 204) are able to view the discussion posts by the registered users and may additional be allowed to submit reactions (e.g., emoji) to the panel discussion, but are not allowed to post content (e.g., text comments, images, video, audio, etc.) to the panel discussion.

Although not shown in FIG. 2, in some embodiments, only some of the non-invited registered users 204 may have access to view and/or submit reactions to the content posted in the panel discussion. For example, a panel discussion may be set up as a ticketed event in which non-invited registered users 204 are required to purchase or otherwise acquire admission (e.g., in the form of an electronic ticket) to view the interactive panel discussion session and/or submit reactions. In such embodiments, the non-invited users 204 with permission to view and submit reactions may be viewed as admitted audience members.

In some embodiments, any non-registered users 206 may be completely blocked from accessing any part of the panel discussion. Alternatively, and as shown in FIG. 2, unregistered users 206 may be allowed to view content posted by panelists (i.e., invited registered users 202) but are not allowed to post content, or submit reactions to the discussion.

An example display 210 of a text-based panel discussion is shown in FIG. 2. In this example panel discussion, posts submitted by multiple panelists A, B and C (i.e., invited registered users 202) are shown. Note that the panel discussion shown in display 210 is in the example form of a text-based discussion (e.g., a listing of forum posts) for illustrative purposes, but is not limited to such an implementation. In other embodiments, the panel discussion may involve live streamed audio and or video from devices associated with invited registered users 202.

The display 210 of the example panel discussion also shows graphical reactions in the form of emoji 212 submitted, for example, by invited registered users 202 and/or non-invited registered users 204. The displayed emoji 212 may represent an aggregated reaction based on many other emoji submitted by the multiple invited registered users 202 and/or non-invited registered users 204. Alternatively, or in addition, the displayed emoji 212 may dynamically update in real time or near real time based on the most recently submitted reaction from invited registered users 202 and/or non-invited registered users 204. Note that the reactions are shown in FIG. 2 as emoji 212 for illustrative purposes, but are not limited to such an implementation. Reactions may alternatively be displayed as other types of graphical indicators such as star ratings, thumbs up/down, up/down arrows, etc. Alternatively, or in addition, reaction from users may include generated audio representative of typical audio reactions such as cheering, booing, etc.

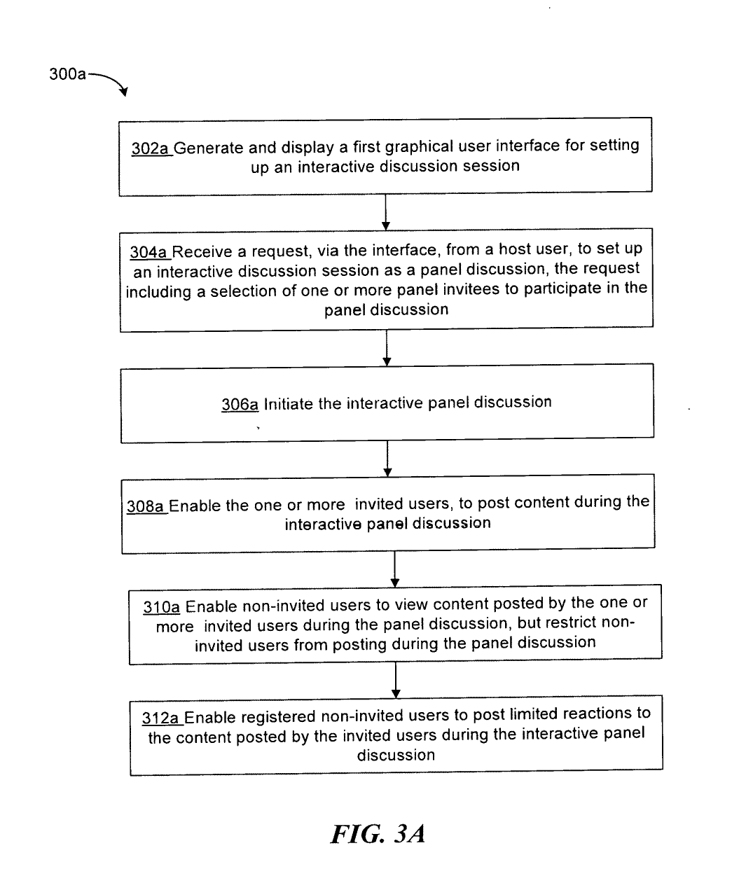

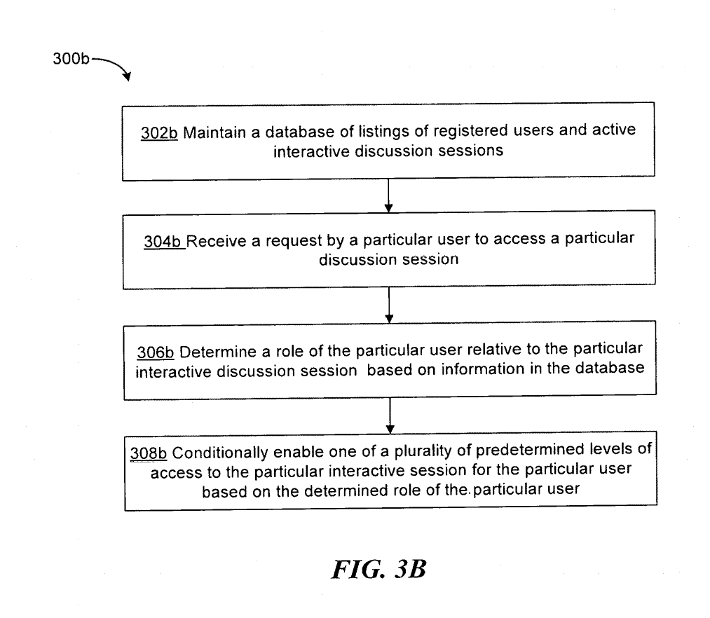

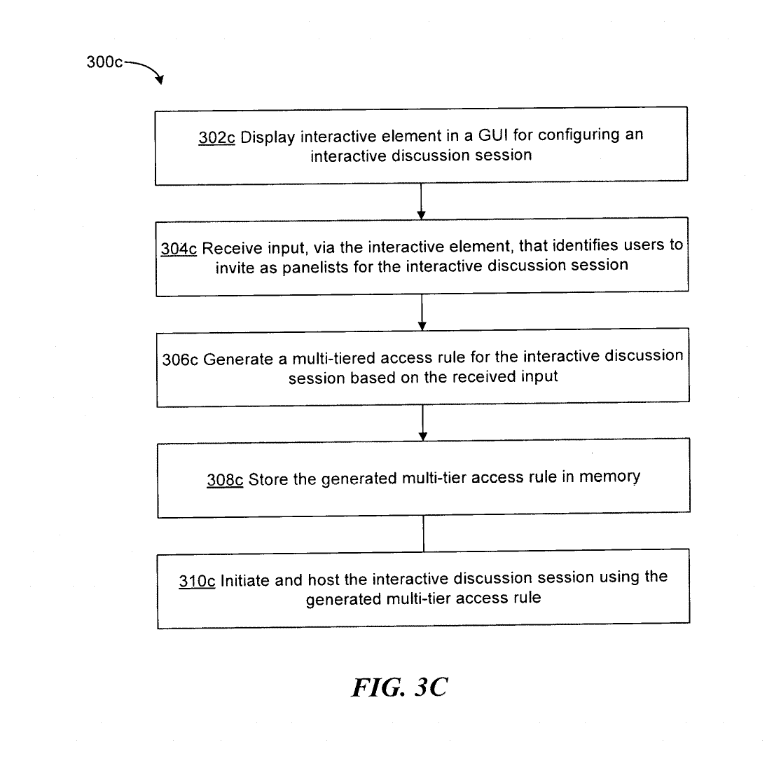

FIGS. 3A-3C are flow diagrams of some example processes for providing interactive panel discussions to users using the introduced techniques. The example processes may be performed by a computing system (e.g., such as computing system 1100 described with respect to FIG. 11). For example, the example processes may be represented in instructions stored in memory that are then executed by a processor. The processes described with respect to FIGS. 3A-3C are examples provided for illustrative purposes and are not to be construed as limiting. Other processes may include more or fewer steps than depicted while remaining within the scope of the present disclosure. Further, the steps depicted in the example processes 3 may be performed in a different order than is shown.

FIG. 3A shows an example process 300a for providing interactive panel discussions to users. As shown in FIG. 3A, the process begins at step 302a with generating and displaying a graphical user interface (GUI) at a user device through which a user (e.g., a host user) can set up an interactive discussion session. In some embodiments, the GUI includes an option for selecting a privacy setting for the interactive discussion. The option may allow a user to set the new interactive discussion session as public, private, or panel discussion. If the panel discussion option is selected, the GUI may also display an interactive option to select one or more invited users to participate in the panel discussion. For example, the host user may input user names or email addresses associated with the selected invited users. Alternatively, or in addition, the host user may select from a number of users in a friend group (e.g., via menu of some type). A person having ordinary skill will recognize that any type of GUI mechanism may be employed to select invited users.

At step 304a, the computing system receives, via the GUI, input from the host user to set up the interactive discussion session. For example, this step may involve receiving a request from the host user to set up a panel discussion, the request including a selection of one or more invitees to participate in the panel discussion.

At step 306a, the computing system initiates the interactive panel discussion based on the received request. In some embodiments, the interactive panel discussion may be initiated immediately in response to the request form the host user. Alternatively, the interactive panel discussion may be imitated at a scheduled time in the future based on the request, when a threshold number of invited panelists have accepted invitations to join, or in response to an additional input by the host user.

With the interactive panel discussion initiated, at step 308a, the computing system may enable the one or more invited users to post content during the interactive panel discussion, as previously described.

At step 310a, the computing system may further enable at any non-invited users (registered and/or not registered) to view content posted by the invited users while restricting the non-invited users from posting their own content to the panel discussion.

At step 312a, the computing system may enable non-invited users that are registered to interact with the panel discussion in some limited manner, for example, by submitting reactions to the discussion in the form or emojis.

FIG. 3B shows another example process 300b for providing interactive panel discussions to users. At step 302b a computing system maintains a database of information utilized by the platform to provide interactive discussion services to users. The database may include listings of registered users where each of the registered users having registered user accounts with the online discussion platform. The database may also include listings of active inter interactive discussion sessions hosted by the platform 106.

At step 304b, the computing system receives, from a user device, a request by a particular user to access a particular interactive discussion session hosted by the platform 106.

In response to the request, at step 306b, the computing system determines a role of the particular user relative to the interactive discussion session based on information in the received request and information in the database. As previously discussed, users that interact with the platform 106 may be classified into various groups such as registered users, non-registered users, panel hosts, panel participants, etc. Each of these groups may be associated with differing user roles related to particular interactive discussion sessions. In some embodiments, determining the role of the particular user may include processing, by the computing system, the received request to determine an identifier associated with the particular user and comparing the identifier associated with the particular user to user identifiers included in the listing of registered users and user identifiers included in a listing of invited users for the particular discussion session.

In response to determining the role of the particular user relative to the particular interactive discussion session, at step 308b, the computing system conditionally enables one of a plurality of predefined levels of access to the particular interactive discussion session for the particular user based on the determined role of the particular user relative to the particular interactive discussion session. For example, the plurality of predetermined levels of access may be defined by a multi-tiered access rule generated, for example, based on configuration inputs by a host user of the interactive discussion session.

In some embodiments, if the role of the particular user is a registered invited user, step 308b may include enabling a first predefined level of access by enabling the particular user to view content in the particular interactive discussion session, submit reactions to content in the particular interactive discussion session, and submit new content to the particular interactive discussion session.

In some embodiments, if the role of the particular user is a registered non-invited user, step 308b may include enabling a second predefined level of access by enabling the particular user to view content in the particular interactive discussion session and submit reactions to content in the particular interactive discussion session, but restricting the particular user from submitting new content to the particular interactive discussion session.

In some embodiments, if the role of the particular user is a non-registered user, step 308b may include enabling a third predefined level of by enabling the particular user to view content in the particular interactive discussion session, but restricting the particular user from submitting reactions to the content in the particular interactive discussion session and restricting the particular user from submitting new content to the particular interactive session.

Enabling a user to submit content to an interactive discussion session may include the computing system causing display in a GUI at a user device, of an interactive prompt, receiving an input including the new content entered by a user via the prompt, and causing display of the new content such that the new content is viewable to other users via their respective user devices.

Enabling a user to submit reactions to content in an interactive discussion session may include the computing system causing display in a GUI at a user device, of an interactive prompt including an option to select one of a plurality of predefined reactions, receiving an input including a selection of a particular reaction entered by a user via the prompt, and causing display of a visual indication (e.g., a graphical emoji) based on the selected reaction in the interactive discussion session such that the visual indication is viewable by other users via their respective user devices. In some embodiments, the displayed visual indication may actually be based on an aggregation of multiple reactions to content submitted by multiple users.

FIG. 3C shows another an example process 300c for configuring an interactive discussion session (e.g., an interactive panel discussion) with multiple user interaction tiers. At step 302c a computing system displays or causes display of an interactive element in a GUI at a user device for configuring an interactive discussion session. An example GUI for setting up an interactive discussion session is shown at FIG. 5. In some embodiments the interactive element in the GUI includes an option to invite users to participate as panelists in the interactive discussion session. For example, the option may include an editable text filed through which a host user can input identifiers (e.g., email address, username, etc.) associated with invited users.

At step 304c, the computing system receives an input entered by a first user (i.e., a host user) via the GUI that includes identifiers associated with one or more invited users to participate as panelists in the interactive discussion session.

At step 306c, the computing system generates automatically a multi-tiered access rule for the interactive discussion session based on the input received at step 304c. In some embodiments, the multi-tiered access rule for the interactive discussion session may include at least three tiers, each of the three tiers applicable to a different classification of users with different roles.

The generated multi-tiered access rule may include a first tier for a first set of users that include any of the one or more invited users identified by the first user (i.e., a host user) at step 304c. This first access tier may enable users that fall under the first set of users (invited users) to view content in the interactive discussion session, submit reactions to content in the interactive discussion session, and submit new content to the interactive discussion session.

The generated multi-tiered access rule may also include a second access tier for a second set of users that includes any other registered users (i.e., with accounts with platform 106) that are not included in the set of invited users. This second access tier may enable users that fall under the second set of users to view content in the interactive discussion session and submit reactions to content in the interactive discussion session, but may restrict such users from submitting new content to the interactive discussion session.

The generated multi-tiered access rule may also include a third access tier for a third set of users that include any non-registered users (i.e., users without an account with platform 106). This third access tier may enable users that fall under the third set of users to view content in the interactive discussion session, but may restrict such users from submitting new content to the interactive discussion and from submitting reactions to content in the interactive panel discussion.

At step 308c, the computing system stores the generated multi-tier access rule in memory. For example, in some embodiments, this step may include storing a multi-tiered access rule generated by the access rules engine 122 in a database 124 and associating the generated access rule to the relevant interactive discussion session.

At step 310c, the computing system initiates and hosts the interactive discussion session using the multi-tiered access rule store in memory.

In some embodiments, after initiating the interactive discussion session, process 300c continues with receiving a request by a second user, from a second user device, to access the interactive discussion session, and applying the multi-tiered access rule stored in memory to conditionally enable one of the multiple predefined levels of access (e.g., tiers one through three) to the interactive discussion session to the second user based on whether the second user is included in any of the sets of users associated with the predefined levels of access.

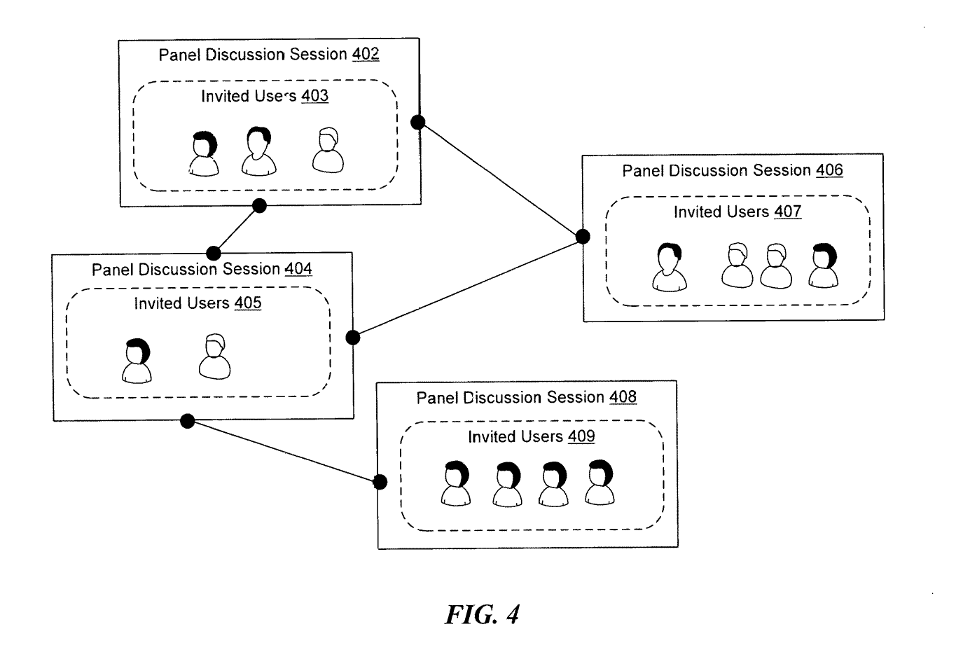

In some embodiments, the platform 106 may allow for linking multiple interactive panel discussions together to facilitate interaction across multiple groups. FIG. 4 shows a diagram illustrating how interactive panel discussion sessions may be linked. As shown in FIG. 4 a first panel discussion 402 includes a first set of invited users 403, a second panel discussion 404 includes a second set of invited users 405, a third panel discussion 406 includes a third set of invited users 407, and a fourth panel discussion 408 includes a fourth set of invited users 409. Note that each of the invited users in the sets 403, 405, 407, and 409 may be different. In some situations, a particular user may be invited to multiple panel discussions meaning that the particular user would be part of the multiple invited user sets.

As shown in FIG. 4, the first panel discussion 402 is linked to the second panel discussion 404 and linked to the third panel discussion 406, as visually indicated by the linking lines. Similarly, second panel discussion 404 is linked to the third panel discussion 406 and linked to the fourth panel discussion 408. The links between panel discussions may have been created by hosts of the respected panel discussions. For example, a host of panel discussion 402 may send an invitation to panel discussion 404 to link the two discussions. The host of panel discussion 404 may elect to accept or deny the invitation to link. In some embodiments, links between panel discussions may be formed automatically, based on a number of factors such as topics associated with the panel discussions, relationships between hosts and/or invited panelists, any organizational arrangements. For example, two popular panel discussions focusing on a particular sports team (as identified based on topics set by the host) may be automatically linked or may at least be automatically identified as candidates for linking with invitations to link sent to the respective hosts. In another example, panel discussions initiated by host users associated with the same organization or enterprise may be automatically linked.

Linking two or more panel discussions together may, in some embodiments allow invited panelists in one panel discussion to post content to the other linked panel discussion and vice versa. In such an embodiment, the panel discussions may remain, at least to a viewing user, as separate discussions, now involving more panelists. Alternatively, or in addition, linking two or more panel discussions may effectively merge the discussions such that they are presented to a viewing user as a single discussion involving posts from the users invited to each of the respective linked panel discussions.

### Illustrative Examples of Interactive Panel Discussions

The following are descriptions of example interactive panel discussions that may be facilitated based on the techniques described herein. These described examples are provided for illustrative purposes and are not to be construed as limiting.

In a first illustrative embodiment, a host user interested in motorcycles sets up an interactive panel discussion to facilitate conversation related to motorcycles. For example, the host user may be a member of a motorcycle club with multiple members. The host user can invite one or more of the other members of the motorcycle club to participate as panelists in the interactive panel discussion. Invited panelists can thereby post comments, questions, etc. during the interactive discussion. In an embodiment, invite panelists can post blog entries that track their motorcycle travels. The blog entry posts may include, for example, images and video taken during their motorcycle travels. Non-invited users that are interested in motorcycles can view and follow the interactive panel discussion, but may be restricted from posting content in order to maintain the high quality and focus of the motorcycle-related interactive panel discussion. To encourage some level of interaction, non-invited users may be allowed to submit reactions (e.g., emoji) to posts submitted by the invited panelists.

In a second illustrative embodiment, a news agency may set up an interactive panel discussion involving candidates in an upcoming election. The invited panelists in this scenario may include the candidates themselves, surrogates associated with the candidates, known political commentators, etc. The invited panelists may carry on an ongoing free from or structured discussion of various issues associated with the election. For example, the interactive panel discussion may follow the format of a text-based forum or may also include lives streamed video segments. Similar to the previous example, non-invited users that are interested in politics can view and follow the interactive panel discussion, but may be restricted from posting content in order to maintain the high quality and focus of the political discussion. To encourage some level of interaction, non-invited users may be allowed to submit reactions (e.g., emoji) to posts submitted by the invited panelists or may be allowed to respond to poll questions submitting by the host. In some cases, the interactive panel discussion may include a moderator. In such cases, non-invited users may be provided the option to submit questions to the panelist that are then reviewed by the moderator. The moderator can select some of these non-invited user questions to post to the interactive panel discussion and/or forward directly to one or more of the panelists.

In a third illustrative embodiment, a television producer may host an interactive panel discussion associated with a new television show. Invited panelists in this scenario may include cast and crew of the television show, critics, etc. The interactive panel discussion may be set up to precede or follow the airing of the television show each week. In some embodiments, a new interactive panel discussion is initiated each episode. In other embodiments, the same interactive panel discussion persists over the course of a season, but with posting limited to certain times before and/or after an episode airs. Fans of the show (non-invited users) may post reactions (e.g., emoji) or may submit questions that are reviewed by a moderator before passing on to a panelist.

### Example Graphical User Interfaces

FIG. 5 shows a screen shot 500 of an example graphical user interface element 502 through which a host user can set up an interactive discussion. As shown in FIG. 5, the example graphical user interface element 502 includes an option 504 to set a privacy setting (public, private, panel, etc.), an option 506 to invite members (i.e., users) to the discussion if set to private or panel, an option 508 to input one or more tags indicative of topics associated with the interactive discussion session, and an option 510 to initiate or publish the interactive discussion once the settings are selected.

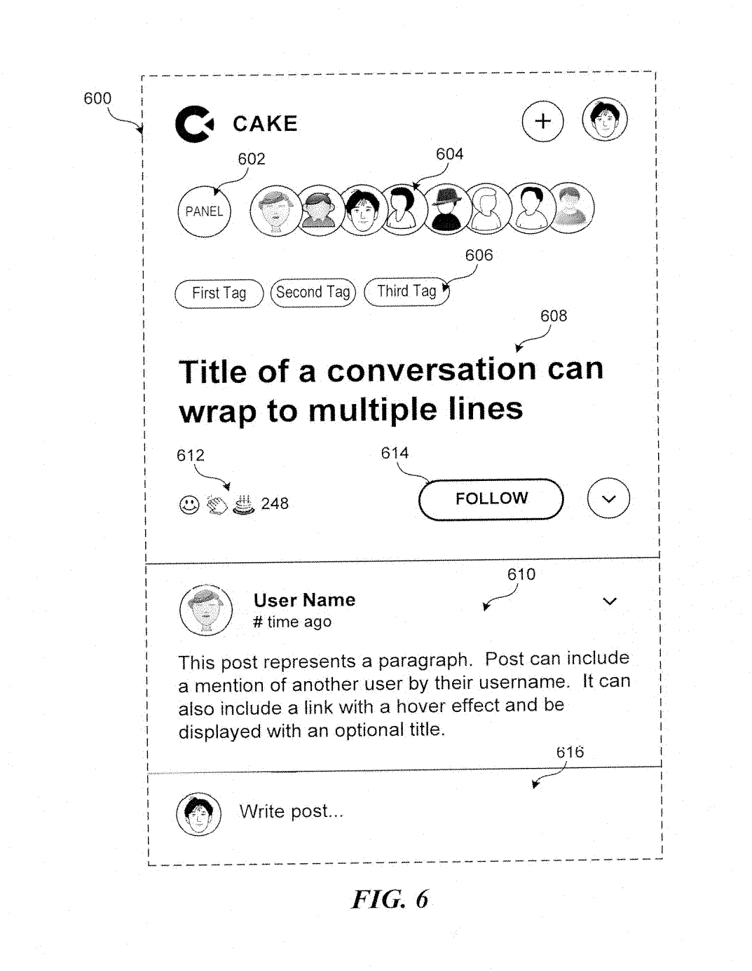

FIG. 6 shows a screen shot of an example graphical user interface 600 displayed to user during an interactive discussion session. As shown in FIG. 6, the graphical user interface 600 includes an indication 602 that the interactive discussion session is a panel discussion and an indication 604 of the invited panelists to the discussion. In this example, the indication 604 of the invited panelists is graphically represented by icons with photos of the invited panelists. The indication 604 may similarly include the names, usernames, handles, etc. of the invited panelists. The example graphical user interface 600 also includes an indication 606 of the tags or topics associated with the discussion and a discussion title 608. Comments posted by invited panelists may show up in a body portion 610 of the interactive discussion session. In this example, the discussion posting is text-based, however other embodiments may include posted images, video, etc., or may include an embedded live video stream from a computing device associated with one or more of the panelists. The example graphical user interface 600 also includes a display 612 of reactions to posts from non-invited users. In this example, the reactions are in the form of emojis. Here, the display 612 of reactions may include an indication of the number of received reactions as well as a display of the most recent or representative emoji based on the received reactions. The example graphical user interface 600 also includes an option 614 to follow the interactive panel discussion and an option 616 to post to the interactive panel discussion (if displayed at a device of an invited panelist).

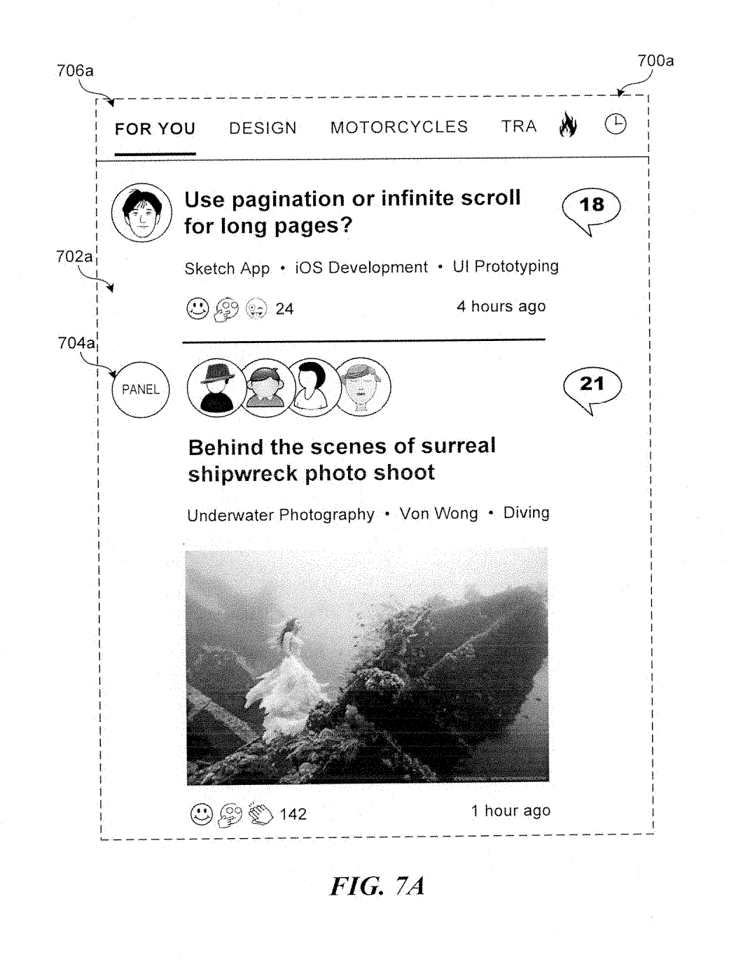

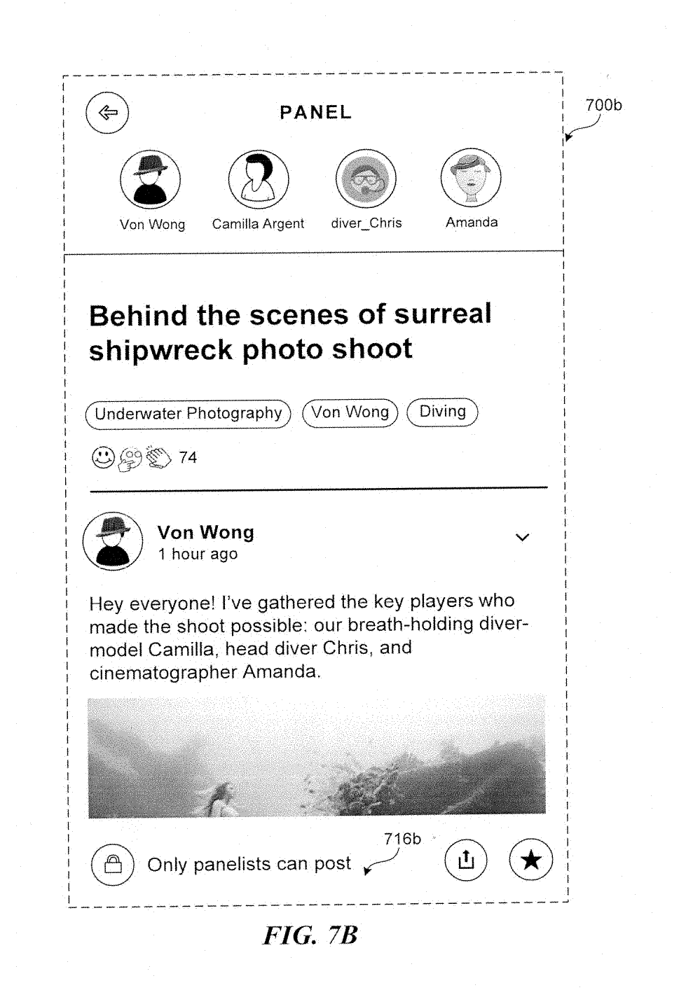

FIGS. 7A-7B show a series of screenshots of an example graphical user interface through which a user can select and view interactive discussion sessions. In FIG. 7A a screenshot 700a is shown of a graphical feed through which a user can select from multiple interactive discussions in session. For example, the feed 700a includes listings of a first discussion 702a and second discussion 704a. As shown in FIG. 7A, the second discussion 704a is a panel discussion. The graphical feed 700a may also include an option 706a to select certain topics or categories of discussions to browse. For example, as shown in FIG. 7A, the current feed 700a is a personalized feed based on user interests. The user may alternatively select other topics such as “design” and “motorcycles” to view.

In response to selecting one of the displayed interactive discussions from the feed 700a, a user may be presented with the graphical user interface 700b depicted in FIG. 7B. In this example, the user has selected the second discussion 704a that is a panel discussion. The interface 700b depicted in FIG. 7B is similar to the interface 600 depicted in FIG. 6 except that the user in this scenario is not an invited panelist and therefore does not have permission to post to the panel discussion, as indicated by the locked posting option 716b.

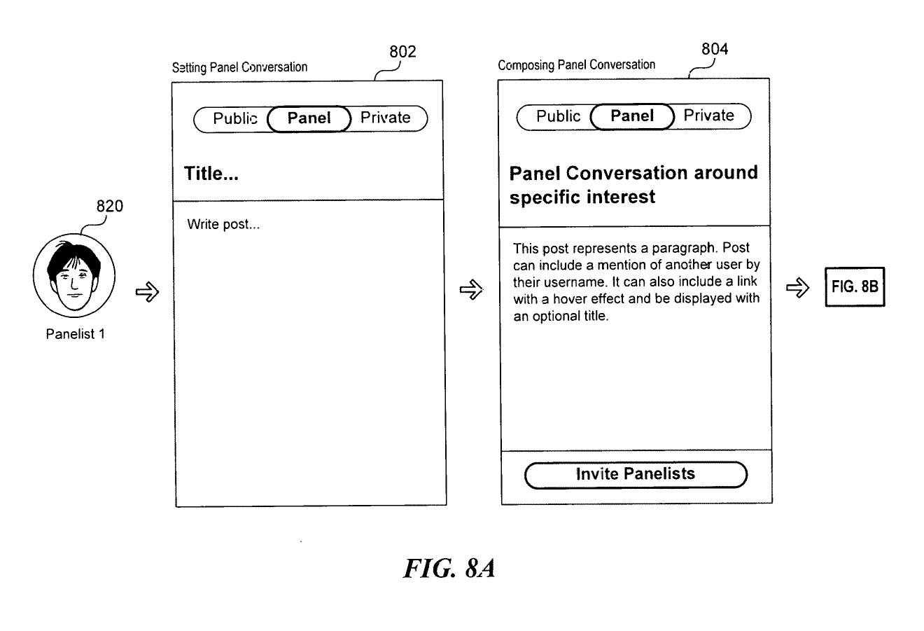

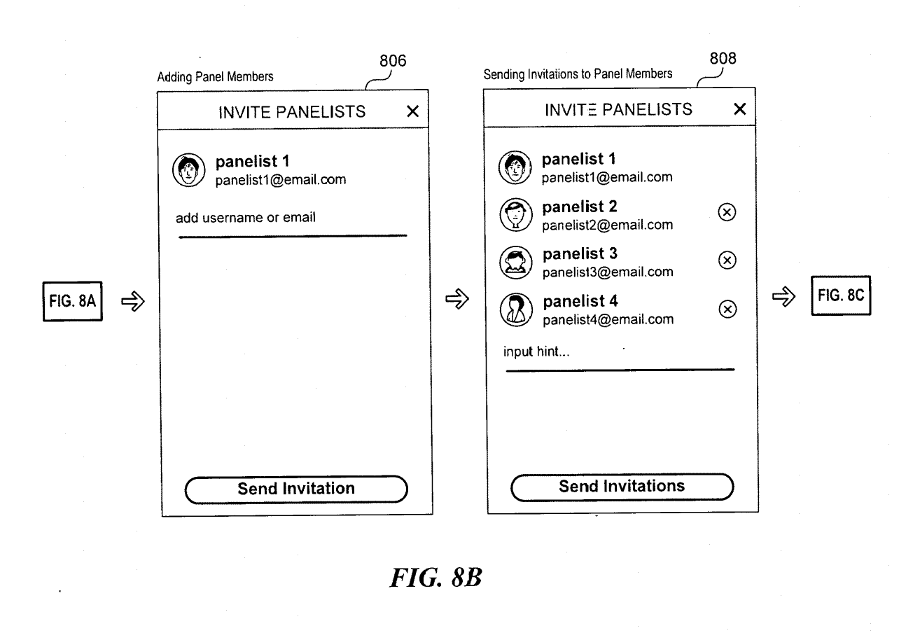

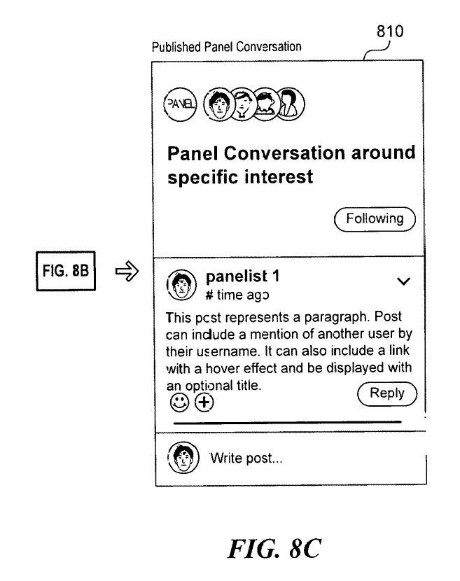

FIGS. 8A-8C show a series of screenshots of graphical user interfaces that illustrate an example interaction flow by a host user 820 setting up a panel discussion. FIG. 8A shows a screen 802 in which the host user 820 is setting up the interactive discussion session as a panel discussion. Next, at screen 804, the host user 820 is presented with options to compose the interactive discussion session (set title, compose descriptions, set topics tags, etc.).

Once the host user 820 has composed the interactive panel discussion, the host user 820 selects the option to invite panelist and is presented with screen 806 (shown in FIG. 8B) through which the host user 820 can select one or more users to participate in the panel discussion as invited panelists. Once the list of invited panelists is set, the host user 820 is presented with screen 808 with an option to send invitations (e.g., via email, text, instant messaging, etc.). Once the interactive discussions session initiates (e.g., after publishing, by the host user 820), the host user 820 can view the conversations associated with the session via screen 810 shown in FIG. 8C. Screen 810 shows an interface similar to that described with respect to FIG. 6.

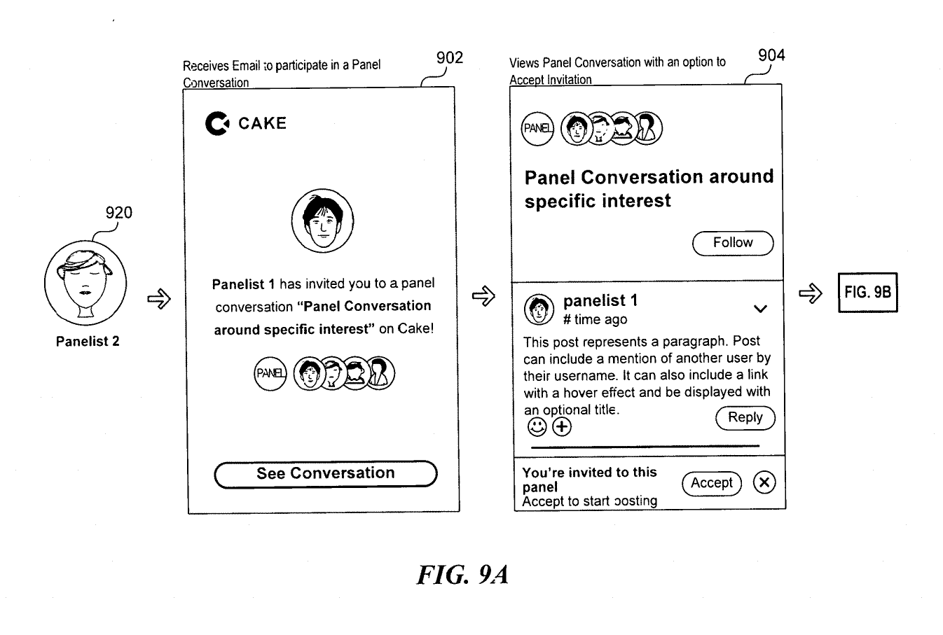

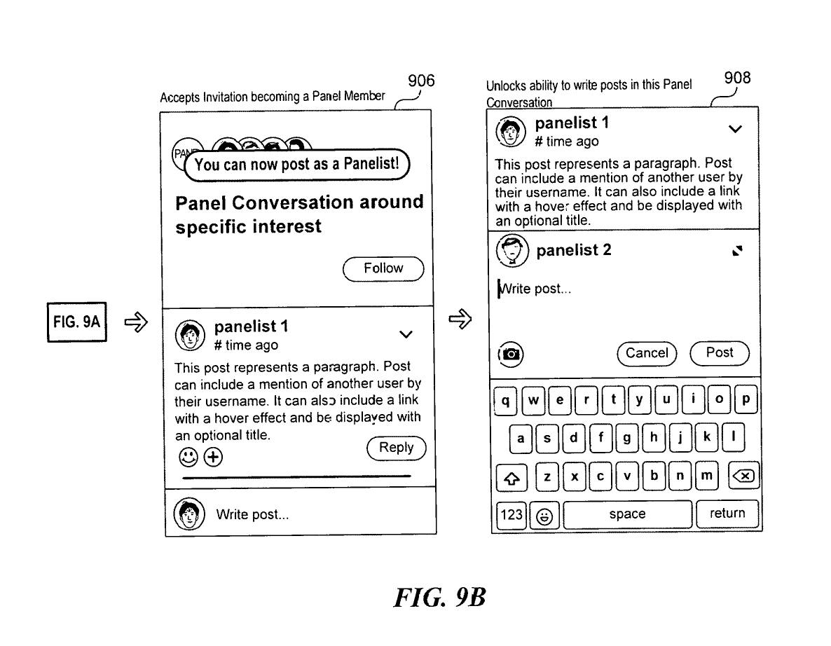

FIGS. 9A-9B show a series of screenshots of graphical user interfaces that illustrate an example interaction flow by a user invited to participate in a panel discussion (i.e., a panelist 920). As shown in FIG. 9A, when invited, by a host user, to participate in a panel discussion, the invited panelist 920 may receive a notification (e.g., in the form of an email) as shown at screen 902. The example notification shown at screen 902 includes information associated with the panel discussion such as an indication of the host user that invited the panelist, a title and/or topic of the panel discussion, and indications of other invited panelists. The notification shown at screen 902 further includes an option for the invited panelist 920 to view the panel discussion.

In response to selecting the option to view the panel discussion, the invited panelist 920 is presented with screen 904 which displays the panel discussion, for example, similar to as described with respect to FIG. 6. The example screen 904 showing the panel discussion further includes an option through which the invited panelist 920 can accept the invitation to join. In response to accepting the invitation to join, the invited panelist is present with screen 906 (shown in FIG. 9B) that is similar to screen 904 except that it now includes an interface through which the invited panelist 920 can post content to the panel discussion. For example, screen 908 (also shown in FIG. 9B) shows a pop up keyboard GUI element through which the invited panelist 920 can input text in a text-based panel discussion. Other interface elements may also be provided depending on the type of content allowed to be posted in the panel discussion.

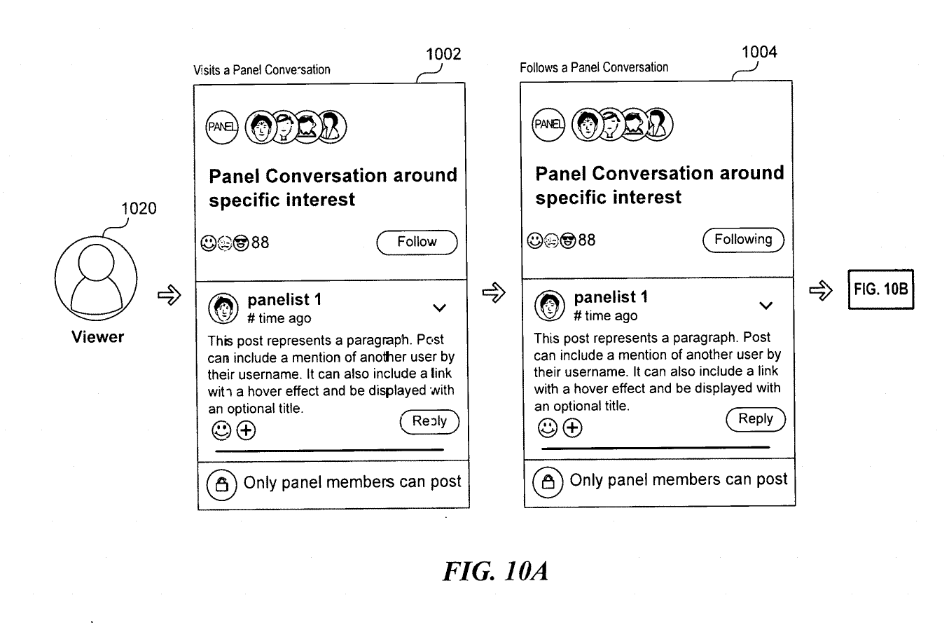

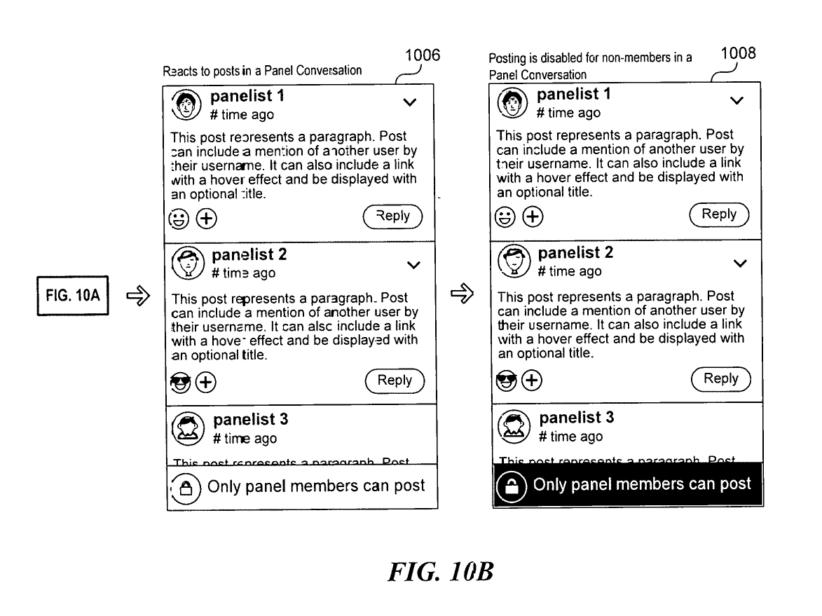

FIGS. 10A-10B show a series of screenshots of graphical user interfaces that illustrate an example interaction flow by a non-invited user 1020 (e.g., a registered user not invited as a panelist) when viewing a panel discussion. When viewing a panel discussion, a non-invited user 1020 may be presented with screen 1002 which displays a view of the panel discussion, for example, similar to as described with respect to FIGS. 7A-7B. Note that the interface element through which to post comments is locked to the non-invited user. Screen 1002 also includes an option to follow the panel discussion. Following a panel discussion may cause the platform 106 to, for example, send notifications to the non-invited user 1020 of new posts in the panel discussion, follow one or more of the invited panelists, present to the non-invited user 1020 other panel discussions with similar topics, pin the panel discussion in the non-invited user's discussion feed (see FIG. 7A), etc. In response to electing to follow the panel discussion shown at screen 1002, the non-invited user 1020 is presented with screen 1004 which shows that the non-invited user 1020 is following the panel discussion.

As previously discussed, the non-invited user 1020 is not permitted to post content in the panel discussion, but may be permitted limited interaction through submitting reactions to posts by invited panelists. Screen 1006 shown in FIG. 10B show an example interface through which a non-invited user 1020 can submit reactions, for example, in the form of emojis. As shown in screen 1006, can submit reactions to individual posts by panelists. Alternatively, or in addition, the non-invited user 1020 may submit reactions to the overall panel discussion. Note reactions are shown in screen 1006 as emojis, but as previously described, can include other types of limited and controlled information (e.g., thumbs up/down, etc.). If the non-invited user 1020 tries to post content to the panel discussion, the non-invited user 1020 may be presented with screen 1008 that highlights that the non-invited user 1020 does not have access to this level of interaction.

### Computer Implementation

FIG. 11 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions, sequential or otherwise, that specify actions to be taken by that machine.

The computing system 1100 may include one or more central processing units (“processors”) 1105, memory 1110, input/output devices 1125, e.g., keyboard and pointing devices, touch devices, display devices, storage devices 1120, e.g., disk drives, and network adapters 1130, e.g., network interfaces, that are connected to an interconnect 1115. The interconnect 1115 is illustrated as an abstraction that represents any one or more separate physical buses, point to point connections, or both connected by appropriate bridges, adapters, or controllers. The interconnect 1115, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called Firewire.

The memory 1110 and storage devices 1120 are computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media, e.g., non-transitory media, and computer readable transmission media.

The instructions stored in memory 1110 can be implemented as software and/or firmware to program the processor 1105 to carry out actions described above. In some embodiments, such software or firmware may be initially provided to the processing system 1100 by downloading it from a remote system through the computing system 1100, e.g., via network adapter 330.

The various embodiments introduced herein can be implemented by, for example, programmable circuitry, e.g., one or more microprocessors, programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

What is claimed is:

1. A method for facilitating interactive panel discussions using an online discussion platform, the method comprising:
maintaining, by a computing system, a database including:
a listing of registered users, each of the registered users having registered user accounts with the online discussion platform; and
a listing of active interactive discussion sessions hosted by the online discussion platform;
receiving, by the computing system, from a user device, a request by a particular user to access a particular interactive discussion session hosted by the online discussion platform;
determining, by the computing system, a role of the particular user relative to the particular interactive discussion session based on information in the received request and information in the database; and
conditionally enabling, by the computing system, one of a plurality of predefined levels of access to the particular interactive discussion session for the particular user based on the determined role of the particular user relative to the particular interactive discussion session, wherein:
if the role of the particular user is a registered invited user, enabling a first predefined level of access to the particular interactive discussion session for the particular user, the first predefined level of access enabling the particular user to view content in the particular interactive discussion session, submit reactions to content in the particular interactive discussion session, and submit new content to the particular interactive discussion session;
if the role of the particular user is a registered non-invited user, enabling a second predefined level of access to the particular interactive discussion session for the particular user, the second predefined level of access enabling the particular user to view content in the particular interactive discussion session and submit reactions to content in the particular interactive discussion session, but restricting the particular user from submitting new content to the particular interactive discussion session; and
if the role of the particular user is a non-registered user, enabling a third predefined level of access to the particular interactive discussion session for the particular user, the third predefined level of access enabling particular user to view content in the particular interactive discussion session, but restricting the particular user from submitting reactions to the content in the particular interactive discussion session and restricting the particular user from submitting new content to the particular interactive discussion session.

2. The method of claim 1, wherein determining the role of the user includes:
processing, by the computing system, the received request to determine an identifier associated with the particular user; and
comparing the identifier associated with the particular user to user identifiers included in the listing of registered users and user identifiers included in a listing of invited users for the particular discussion session.

3. The method of claim 1, wherein enabling the particular user to submit new content to the particular interactive discussion session includes:
causing display, by the computing system, in a graphical user interface (GUI) at the user device, of an interactive prompt;
receiving, by the computing device, an input entered by the user via the prompt, the input including the new content; and
causing display, by the computing device, of the new content in the particular interactive discussion session such that the new content is viewable to other users via user devices associated with the other users.

4. The method of claim 1, wherein enabling the particular user to submit the reaction includes:
causing display, by the computing system, in a GUI at the user device, of an interactive prompt including an option to select one of a plurality of predefined reactions;
receiving, by the computing device, an input entered by the user via the prompt, the input including a selection of a particular reaction from the plurality of predefined reactions; and
causing display, by the computing system, of a visual indication based on the selected particular reaction in the particular interactive discussion session such that the visual indication is viewable by other users via user devices associated with the other users

5. The method of claim 4, wherein the indication based on the selected particular reaction is a graphical emoji.

6. The method of claim 4, wherein enabling the particular user to submit the reaction further includes:
aggregating, by the computing system, the selected particular reaction with reactions selected by a plurality of other users to generate an aggregated reaction;
wherein the indication is based on the aggregated reaction.

7. The method of claim 1, wherein enabling the particular user to view the content includes:
causing display, by the computing system, in a GUI of the user device, of the content of the particular interactive discussion session.

8. The method of claim 1, further comprising:
causing display, by the computing system, in a GUI of the user device, of an interactive prompt including an option to initiate a new interactive discussion session if the particular user is a registered user;
receiving, by the computing device, an input entered by the user via the prompt, the input defining characteristics of the new interactive discussion session, the characteristics including a listing of invited users to participate as panelists in the new interactive discussion session;
initiating, by the computing system, the new interactive discussion session in response to receiving the input; and
adding an entry for the new interactive discussion session to the listing of active interactive discussion sessions, the entry including the listing of invited users.

9. The method of claim 8, further comprising:
transmitting automatically, by the computing system, invitations to participate as panelists in the new interactive discussion session to user devices associated with each of the invited users.

10. A method for configuring an interactive panel discussion with multiple user interaction tiers, the method performed by a computing system operating as part of an online communications platform configured to host a plurality of interactive panel discussions accessible to users via network-connected user devices, the method comprising:
causing display, in a GUI at a first network connected user device, of an interactive element for configuring the interactive panel discussion, the interactive element including an option to invite users to participate as panelists in the interactive panel discussion;
receiving an input entered by a first user via the GUI at the first user device, the input including identifiers associated with one or more invited users to participate as panelists in the interactive panel discussion;
generating automatically a multi-tiered access rule for the interactive panel discussion based on the received input, wherein the multi-tiered access rule defines:
a first access tier for a first set of users, the first set of users including any of the one or more invited users that have registered accounts with the online communications platform, the first access tier enabling the first set of users to view content in the interactive panel discussion, submit reactions to content in the interactive panel discussion, and submit new content to the interactive panel discussion;
a second access tier for a second set of users, the second set of users including any other users with registered accounts except for the one or more invited users, the second access tier enabling the second set of users to view content in the interactive panel discussion and submit reactions to content in the interactive panel discussion, the second access tier restricting the second set of users from submitting new content to the interactive panel discussion; and
a third access tier for a third set of users, the third set of users including any users without a registered account, the third access tier enabling the third set of users to view content in the interactive panel discussion, the third access tier restricting the third set of users from submitting new content to the interactive panel discussion and from submitting reactions to content in the interactive panel discussion;
storing the generated multi-tiered access rule for the interactive panel discussion in memory accessible to the computing system; and
initiating and hosting the interactive panel discussion using the multi-tiered access rule.

11. The method of claim 10, further comprising:
receiving a request by a second user, from a second user device, to access the interactive panel discussion; and
applying the multi-tiered access rule to conditionally enable access to the interactive panel discussion to the second user based on whether the second user is included in any of the first set of users, second set of users, or third set of users.

12. The method of claim 11, wherein applying the multi-tiered access rule includes:
processing the received request to determine an identifier associated with the second user; and
comparing the identifier associated with the second user to user identifiers included in a listing of registered users stored in the database and user identifiers included in a listing of invited users for the interactive panel discussion included in the multi-tiered access rule for the interactive panel discussion.

13. The method of claim 11, wherein applying the multi-tiered access rule includes:
determining that the second user is an invited user; and
enabling the second user to submit new content to the interactive panel discussion by:
causing display, in a graphical user interface (GUI) at the second user device, of an interactive prompt;
receiving an input entered by the second user via the prompt, the input including the new content; and
causing display, by the computing device, of the new content in the interactive panel discussion such that the new content is viewable to other users via user devices associated with the other users.

14. The method of claim 11, wherein applying the multi-tiered access rule includes:
determining that the second user is a registered user; and
enabling the second user to submit reactions to the content in the interactive panel discussion by:
causing display, in a GUI at the second user device, of an interactive prompt including an option to select one of a plurality of predefined reactions;
receiving an input entered by the second user via the prompt, the input including a selection of a particular reaction from the plurality of predefined reactions; and
causing display of a visual indication based on the selected particular reaction in the interactive panel discussion such that the visual indication is viewable by other users via user devices associated with the other users.

15. The method of claim 14, wherein the visual indication based on the selected particular reaction is a graphical emoji.

16. The method of claim 14, wherein enabling the second user to submit the reaction further includes:
aggregating the selected particular reaction with reactions selected by a plurality of other users to generate an aggregated reaction;
wherein the visual indication is based on the aggregated reaction.

17. The method of claim 14, wherein applying the multi-tiered access rule includes enabling the second user to view the content in the interactive panel discussion by:
causing display, in a GUI of the second user device, of the content of the interactive panel discussion.

18. A system for facilitating interactive panel discussions, the system comprising:
a database configured to store information used for facilitating interactive discussion session, the database including:
a listing of registered users, each of the registered users having registered user accounts with the system; and
a listing of active interactive discussion sessions hosted by the system;
a session configuration module configured to:
receive, from a host user, identifiers associated with one or more users invited by the host user to participate as panelists in an interactive panel discussion; and
output the identifiers to an access rule engine;
an access rule engine configured to:
receive the identifiers from the session configuration module; and
generate automatically a multi-tiered access rule for the interactive panel discussion based on the received identifiers and the listing of registered users in the database, wherein the multi-tiered access rule defines:
a first access tier for a first set of users, the first set of users including any of the one or more registered users that have been invited by the host user to participate as panelists in the interactive panel discussion, the first access tier enabling the first set of users to view content in the interactive panel discussion, submit reactions to content in the interactive panel discussion, and submit new content to the interactive panel discussion;
a second access tier for a second set of users, the second set of users including any other registered users that have not been invited by the host user to participate as panelists in the interactive panel discussion, the second access tier enabling the second set of users to view content in the interactive panel discussion and submit reactions to content in the interactive panel discussion, the second access tier restricting the second set of users from submitting new content to the interactive panel discussion; and
a third access tier for a third set of users, the third set of users including any users that are not registered users, the third access tier enabling the third set of users to view content in the interactive panel discussion, the third access tier restricting the third set of users from submitting new content to the interactive panel discussion and from submitting reactions to content in the interactive panel discussion; and
store the generated multi-tiered access rule for the interactive panel discussion in memory accessible to the system; and
a session handler configured to:
initiate the interactive panel discussion;
manage access to the interactive panel discussion by applying the multi-tiered access rule.

19. The system of claim 18, wherein applying the multi-tiered access rule includes:
receiving a request from a particular user to access the interactive discussion session;
processing the received request to determine an identifier associated with the particular user;
comparing the identifier associated with the particular user to user identifiers included in the listing of registered users and user identifiers included in a listing of invited users for the particular discussion session;
determining, based on the comparing, that the particular user belongs to any of the first set of users, the second set of users, or the third set of users; and
conditionally enabling access for the particular user based on any of the first access tier, second access tier, or third access tier based on the determining.

20. The system of claim 18, further comprising:
an application installed at a network-connected user device configured to generate and display a GUI through which a user can access the interactive discussion session;
wherein applying the multi-tiered access rule includes:
enabling the user to submit new content to the interactive discussion session via the GUI if the user belongs to the first set of users;
enabling the user to submit reactions to content in the interactive discussion session via the GUI if the user belongs to any of the first or second set of users; and
enabling the user to view content in the interactive discussion session via the GUI if the user belongs to any of the first set of users, second set of users, or third set of users.

21. A method for enabling access to interactive discussion sessions hosted by an online discussion platform, the method performed by an application installed at a network-connected user computing device, the method comprising:
causing display, by the application, via a display device of the network-connected user computing device, of a first graphical user interface (GUI) comprising a graphical feed of a plurality of listings of interactive discussion sessions hosted by the online discussion platform;
receiving, by the application, via an input device of the network-connected user computing device, a selection by a particular user of a particular listing from the plurality of listings in the graphical feed, the particular listing associated with a panel discussion involving a plurality of panelist, the plurality of panelists including users invited of the online discussion platform invited to participate in the panel discussion;
in response to the selection, causing display, by the application, via the display device of a second GUI, the second GUI including:
a first graphical element displaying a visual indication of identities of the plurality of invited panelists;
a second graphical element displaying a visual indication of reactions to the panel discussion;
a third graphical element displaying a plurality of content items posted by one or more of the invited panelists; and
an option that conditionally enables the particular user to post content in the interactive discussion based on whether the particular user is included as one of the plurality of panelists.

22. The method of claim 21, further comprising:
detecting, by the application, interaction by the particular user with the option to post content in the interactive discussion session; and
determining, by the application, whether the particular user is included as one of the invited panelists;
if the particular user is included as one of the invited panelists:
receiving, by the application, an input by the user including a new content to post to the panel discussion; and
transmitting, by the application, via a computer network, the new content to the online discussion platform for publication to the panel discussion, wherein publication to the panel discussion enables other users accessing the panel discussion to view the new content; and
if the particular user is not included as one of the invited panelists:
restricting, by the application, the particular user from inputting the new content to post to the panel discussion.

23. The method of claim 21, wherein determining whether the particular user is included as one of the invited panelists includes:
determining, by the application, a particular identifier associated with the particular user;
accessing, by the application, via a computer network, a database associated with the online discussion platform for identifiers associated with the plurality of panelists for the panel discussion; and
comparing the particular identifier associated with the particular user with the identifiers associated with the plurality of panelists.

24. The method of claim 21, wherein each of the plurality of content items in the third graphical element include an option that conditionally enables the particular user to submit a reaction to content posted by the one or more panelists.

25. The method of claim 24, further comprising:
detecting, by the application, interaction by the particular user with the option to submit a reaction to content posted by the one or more panelists; and
determining, by the application, whether the particular user has a registered account with the online discussion platform; and
if the particular user does have a registered account:
causing display, by the application, of an interactive prompt including an option to select one of a plurality of predefined reactions;
receiving, by the application, via the prompt, a selection by the particular user of a particular reaction from the plurality of predefined reactions; and
updating, by the application, the visual indication of reactions to the panel discussion included in the second graphical element based on the particular reaction selected by the particular user.

26. The method of claim 25, wherein updating the visual indication of reaction to the panel discussion includes:
aggregating the particular reaction with a plurality of other reactions selected by other users to generate an aggregate reaction to the panel discussion; and
updating the visual indication based on the aggregate reaction.

27. The method of claim 21, wherein the visual indication of identities of the plurality of invited panelists displayed in the first graphical element includes a plurality of graphical icons, each of the plurality of graphical icons including a photo of one of the plurality of invited panelists.

28. The method of claim 21, wherein the plurality of listings of interactive discussion sessions included in the graphical feed of the first GUI are selected specifically for the particular user based on any of user preferences for the particular user or previous interaction by the particular user with the online discussion platform.

29. The method of claim 21, wherein the network-connected user computing device is a wireless mobile computing device.

30. The method of claim 21, wherein the application is any of a web browser application or mobile application.

31. The method of claim 21, wherein the application communicates with the online discussion platform using an application program interface (API).

32. A user computing device comprising:
a display device configured to display visual outputs to a user;
an input device configured to received inputs entered by a user;
a network device configured for communication with other computing devices over a computer network
a processor communicatively; and
a memory communicatively coupled to the processor, the memory storing an application including instructions, which when executed by the processor, cause the user computing device to:
display, via the display device, a graphical user interface (GUI) including:
a graphical feed of one or more content items posted by one or more of a plurality of panelist users to an interactive panel discussion hosted by an online discussion platform, the plurality of panelist users invited by a host user that initiated the interactive panel discussion;
wherein each of the one or more content items includes a reaction input element that conditionally enables the user to input limited reactions to content items based on whether the user is a registered user with an account with the online discussion platform; and
a content input element that conditionally enables the user to post content in the interactive panel discussion based on whether the user is one of the plurality of panelist users.

33. The user computing device of claim 32, wherein the application includes further instructions, which when executed by the processor, cause the user computing device to conditionally enable the user to input limited reactions to content items using the reaction input element by:
detecting a user interaction with the reaction input element based on inputs received via the input device;
communicating, via the network device, with a server associated with the online discussion platform to authenticate the user as a registered user with an account with the online discussion platform;
displaying, via the GUI, a graphical prompt to the user to select one of a plurality of predefined reactions in response to receiving, from the server, an acknowledgement that the user is a registered user;
receiving, via the graphical prompt, a selection by the user of a particular reaction from the plurality of predefined reactions;
transmitting, via the network device, to the server, an indication of the selection by the user of the particular reaction;
receiving, via the network device, from the server, an indication of an aggregate reaction to one or more of the content items in the graphical feed, the aggregate reaction based on the indication of the selection by the user of the particular reaction and indications of selections of other reactions by a plurality of other users; and
displaying, via the GUI, a visual indication of the aggregate reaction.

34. The user computing device of claim 33, wherein the visual indication of the aggregate reaction includes one or more graphical emoji.

35. The user computing device of claim 32, wherein the application includes further instructions, which when executed by the processor, cause the user computing device to conditionally enable the user to post content in the interactive panel discussion using the content input element by:
detecting a user interaction with the content input element based on inputs received via the input device;
communicating, via the network device, with a server associated with the online discussion platform to authenticate the user as one of the plurality of panelists users;
displaying, via the GUI, a graphical prompt to the user to input a new content item to post to the interactive panel discussion in response to receiving, from the server, an acknowledgement that the user is one of the plurality of panelist users;
receiving, via the graphical prompt, an input by the user including the new content; and
transmitting, via the network device, to the server, the new content input by the user; and
updating the graphical feed with the new content input by the user in response to receiving an indication form the server that the new content has been posted to the interactive panel discussion, wherein once posted, the new content is viewable by other users via their respective devices.

36. The user computing device of claim 32, wherein the GUI further includes any of:
a title of the interactive panel discussion;
images of one or more of the plurality of panelist users;
visual tags indicative of topics associated with the interactive panel discussion; or
a visual indication of one or more reactions to content submitted by one or more registered users of the online discussion platform.

37. The user computing device of claim 32, wherein the user computing device is a mobile computing device and wherein the display device and input device are integrated as a touch screen display.

38. The user computing device of claim 32, wherein the application is any of a web browser application or mobile application.

39. The user computing device of claim 32, wherein the application communicates with the online discussion platform using an application program interface (API).
